(19) United States
(12) Patent Application Publication
(10) Pub. No.: US 2004/0044566 A1
(43) Pub. Date: Mar. 4, 2004

(54) Landing page and channel identifier in multichannel marketing system

(76) Inventors: Janet K. Bostelmann, Santa Fe, NM (US); Casey L. Gentry, Atlanta, GA (US); Thomas Y. Kwok, Township, NJ (US); Linh H. Lam, Yorktown Heights, NY (US); Thao N. Nguyen, Katonah, NY (US); Kakan Roy, Ossining, NY (US)

Correspondence Address: THE LAW OFFICE OF IDO TUCHMAN, 69-60 108ST., SUITE 503, FOREST HILLS, NY, 11375, US

(21) Appl. No.: 10/232,056

(22) Filed: Aug. 30, 2002

(51) Int. Cl. G06F 17/60

(52) U.S. Cl. 705/14

(57) ABSTRACT

A method, system and computer program for providing content from a merchant site to a target user over a computer network. The merchant site provides a landing page to the target user in response to a request for data. The landing page includes a redirect module configured to redirect the target user to a destination page. The landing page also includes a cookie module configured to store a computer readable client cookie in memory identifying the marketing channel referring the target user to the merchant site.

### FIELD OF THE INVENTION

The present invention relates to electronic commerce in a network environment. More specifically, the invention relates to online marketing of products and services using a landing page and a client cookie.

### BACKGROUND

The World Wide Web (also called “the Web”) has become a new medium for business and commerce. By creating online stores, merchants routinely offer their goods and services for sale over public web sites. Businesses sometimes operate multiple online stores, or have different product categories from different product divisions under the same online store. Even though sales can originate from various marketing channels, in general, sales under the same merchant go through the same transaction database and back end procurement system for simplicity, efficiency, and cost savings. Therefore, merchants typically desire a means of tracking sales originating from each online store, product category, or product division for future production, sales, and marketing strategies.

Advertising on the Web offers revenue potential to many popular or frequently visited web sites willing to sell advertising space. Many affiliate marketing programs have been created to link web sites selling advertising space to merchants. As a result of such affiliate marketing programs, merchants are sometimes interested in tracking a sales process from the original market channel, through the sale transaction, to the back end procurement. Such tracking is often necessary to credit commission payments to affiliate partners that refer customers to the merchant web sites. This type of market tracking process is commonly referred to as session tracking from an inbound source to net sale.

As Internet marketing programs become more complex and sophisticated, companies and vendors may need to track many marketing sources, such as different affiliate partners, e-mail, print and television advertisement campaigns, as well as e-coupon or e-rebate programs. Hence, there is an increasing need for business tracking technologies to systematically monitor sales from such different multichannel marketing programs.

One solution known in the art is using unique permanent identifiers, such as browser cookies, to store and retrieve marketing data in client memory. This and other conventional solutions, however, are often limited by browser restrictions on the number, size, and duration of cookies that can exist in client memory. Furthermore, such solutions are often difficult to administer, debug, and adapt as new marketing channels are introduced and old channel are removed.

Another difficulty faced by some merchants is payment of commissions when more than one affiliate partner refers the target user to merchant's site. Such a situation can occur when the merchant has a large number of affiliates linking to the merchant's site. A customer can thus click on a merchant's banner at different affiliate sites at different times before a purchase is completed. This presents an issue of which affiliate should receive the sales commission or how to divide the commission among the deserving affiliates. Typically, the merchant pays a sales commission only to the most recent affiliate that leads the customer to the merchant because of an inability to account for multiple referring affiliates. Often times, however, such an arrangement deprives earlier referring affiliates from receiving at least a portion of the sales commission. The lack of a mechanism to determine accurately and fairly the referral compensation for earlier referring affiliates can diminish the incentive of affiliates to display the merchant's advertisements, thereby reducing the effectiveness of the merchant's affiliate marketing program.

### SUMMARY OF THE INVENTION

The present invention addresses the above-identified problems with the prior art by providing a landing page (also referred to as a transient page) and a client cookie to help track, control, and distribute network traffic at a merchant site. The invention harmonizes and simplifies content delivery to target users originating from various network sources and marketing channels.

Thus, one aspect of the invention is a method for providing content from a merchant site to a target user over a computer network, where the target user is referred to the merchant site by a marketing source. The method includes receiving a request for information from the target user. A landing page is provided to the target user in response to the request. The landing page is configured to record an identifier of the marketing source in a client cookie. A redirecting step redirects the target user from the landing page to a destination page providing content to the target user.

Another aspect of the invention is a landing page adapted to be downloaded by a client from a server over a computer network, where the client is referred to the server by a marketing channel. The landing page includes a redirect module configured to redirect the client to a destination page. The landing page also includes a cookie module configured to store a computer readable client cookie in memory and identify the marketing channel.

Yet another aspect of the invention is a system for controlling the content delivered to a target user from a merchant site in a network environment. The network environment includes a plurality of network sources. The system comprises a network source and a landing page. The network source provides the target user with a link to the merchant site. The landing page is adapted to be downloaded by the target user from the merchant site over the computer network. The landing page includes a redirect module configured to redirect the target user to a destination page of the merchant site, and a cookie module configured to store a computer readable client cookie in memory. Furthermore, the client cookie is configured to identify the network source.

Another aspect of the invention is a computer program product for providing content from a merchant site to a target user over a computer network. The target user is referred to the merchant site by a marketing source. The program product includes program codes to receive a request for information from the target user, provide a landing page to the target user in response to the request, and redirect the target user from the landing page to a destination page. The landing page is configured to record an identifier of the marketing source in a client cookie, and the destination page provides content to the target user.

A further aspect of the invention is a client cookie embodied in tangible media at a client computer, where the client computer is referred to a server destination by a marketing channel. The client cookie includes a channel identity field configured to record an identity of the marketing channel. The client cookie also includes a time stamp field configured to record an expiration date of at least one commission attributable to the marketing channel.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an exemplary computer network environment embodying the present invention.

FIG. 2 shows a block diagram of a system contemplated by the present invention.

FIG. 3 shows an exemplary client cookie utilized by the present invention.

FIG. 4 shows a landing page contemplated by the present invention.

FIGS. 5A-5C show a flowchart for providing content from a merchant site to a target user over a computer network, as contemplated by one embodiment of the present invention.

FIG. 6 shows another embodiment of a client cookie contemplated by the present invention.

### DETAILED DESCRIPTION OF THE INVENTION

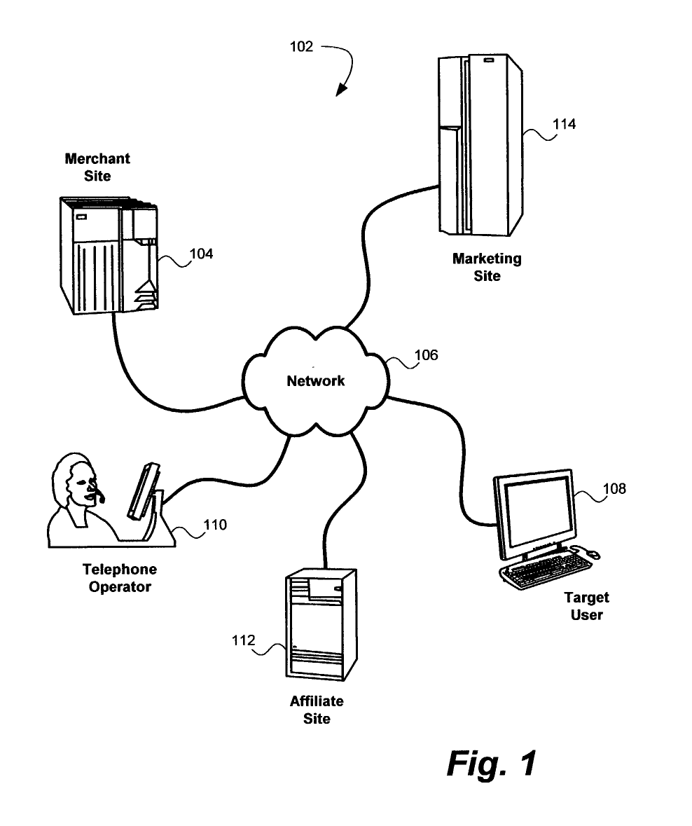

In general, the present invention is a novel system, method, and computer program to help manage and harmonize network traffic originating from various marketing sources in a computer network. The invention is described in detail below with reference to FIGS. 1-6. When referring to the figures, like structures and elements shown throughout are indicated with like reference numerals.

In FIG. 1, a network environment 102 embodying the present invention is shown. It is noted that the network environment 102 described herein is a simplified configuration for illustration purposes only, and is not intended to limit the invention to the arrangement shown.

The environment 102 includes a merchant network site 104 coupled to a network 106. The merchant site 104 is representative of a computer system utilizing the present invention to control and/or track network traffic at a network site. The merchant site 104 can include a group of network sites and/or a set of sub-merchant sites. Typically, the merchant site 104 is embodied on one or more web servers coupled to the network 106 and belonging to a business. For example, the merchant site 104 may provide product information and on-line shopping capabilities for golf clubs sold over the network 106 by a golf club retailer. It is contemplated, however, that the merchant site 104 may belong to any entity with a network presence, including, but not limited to, commercial, individual, educational, and governmental entities.

In most cases, information about products and services on the merchant site 104, also referred to herein as content, is organized and divided among various web pages formatted in Hyper Text Markup Language (HTML) or other languages, such as Extensible Markup Language (XML). The web pages can be displayed using a web browser program. The merchant site 104 may also execute various programs and scripts in response to data received from the network 106. One example of such interactive programs is a shopping cart program that allows site visitors to add, subtract, and ultimately purchase products and services over the network 106.

The network 106 may be any type of network known to those skilled in the art for effectuating electronic communication within the environment 102. For example, the network 106 may be a public network, such as the Internet, a wide area network, a local area network, or any combination thereof. The network 106 may be either wired or wireless. In a particular embodiment of the invention, the network 106 is configured to communicate data packets using standard Hyper Text Transfer Protocol (HTTP) or other protocols.

The environment further includes a target user 108, also referred to herein as a client. The target user 108 represents an individual or other entity interested in the products or services presented by the merchant site 104. For instance, the target user 108 may be a golfer interested in golf clubs sold over the merchant site 104. The target user 108 may view and interact with information on the merchant site 104 using a web browser such as Netscape Navigator(R) or Microsoft(R) Internet Explorer. Netscape Navigator is a registered trademark of Netscape Communications Corporation, and Microsoft is a registered trademark of Microsoft Corporation. Although the target user 108 is shown directly connected to the network 106, it is contemplated that the invention may be utilized without such a connection. For example, the target user 108 may indirectly communicate with the merchant site 104 through a telephone operator 110 relaying data from the target user 108 to the merchant site 104 over a telephone line.

The network environment 102 may also include an affiliate site 112 and a marketing site 114. An affiliate site 112 is typically embodied in an affiliate server and contains a direct or indirect link to the merchant site 104. For example, the affiliate site 112 may include a message board for golfers and may contain an advertisement for golf clubs sold on the merchant site 104. Furthermore, the advertisement can include a link which, when activated, directs the target user 108 to the merchant site 104.

A marketing site 114 is often employed as a trusted third party in situations where the affiliate receives a commission from the merchant based on the number of shoppers directed to the merchant site 104 from the affiliate site 112. In such arrangements, when the target user 108 selects the merchant's advertisement link on the affiliate site 112, the target user 108 is first directed to the marketing site 114 and is then transferred to the merchant site 104. The marketing site 114, can keep count of affiliate referrals and can provide tracking identifiers to determine if the referred user ultimately makes a purchase on the merchant site 104.

In addition to the situations discussed above, network traffic at the merchant site 104 may originate from many other sources. For example, the merchant may conduct an e-mail, radio, television, or paper advertisement campaign containing a link or reference to the merchant site 104. As described in detail below, the present invention provides a unique system to centralize, control, distribute, and track network traffic form the these various market channels.

In brief, the merchant site 104 provides a landing page for network traffic originating from various market channels. Moreover, a persistent client identifier is used to record which marketing channel directed the target user 108 to the merchant site 104. In this manner, the invention helps the merchant evaluate a marketing campaign's effectiveness, customize page content according to the user's origin, manage referral commissions, and efficiently utilize limited computer resources.

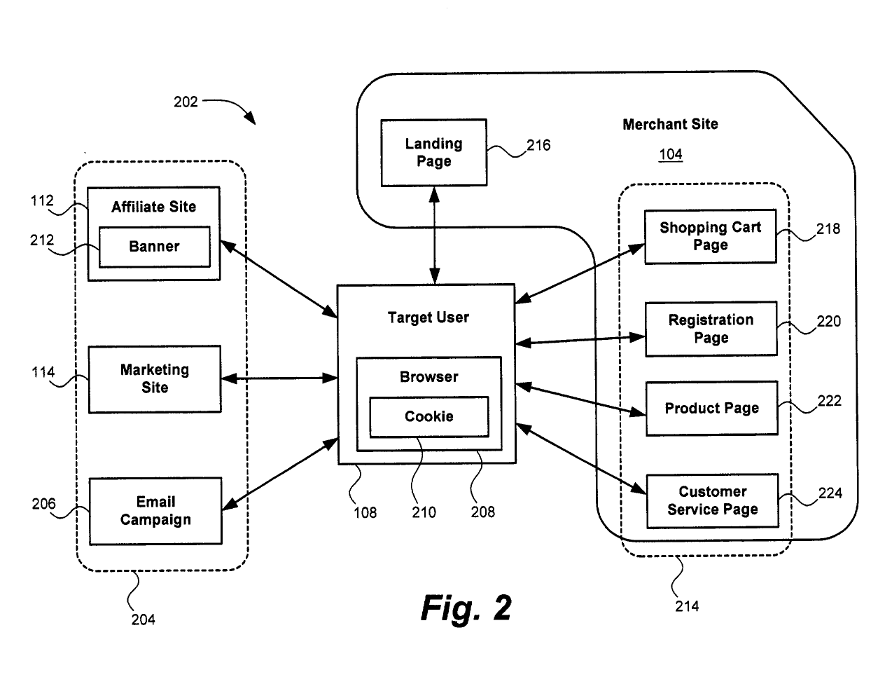

In FIG. 2, a block diagram of a system 202 contemplated by the present invention is shown. The system 202 includes a number of market sources 204 directing the target user 108 to the merchant site 104. The market sources 204 may include, for example, an affiliate site 112 advertising products or services offered at the merchant site 104, a marketing site 114 directing the target user 108 to the merchant site 104, and an e-mail campaign 206 describing the merchant's products or services and including a link to the merchant site 104.

The target user 108 includes a network browser 208 to view and interact with content from the various network sources 204 and the merchant site 104. Typically, the browser 208 sends a session request to a server addressed by a Uniform Resource Locator (URL). The referenced server replies with information formatted in HTML and displayed in the browser 208. In addition, the browser 208 is typically capable of storing a persistent client cookie 210 in the target user's memory. The client cookie 210 is also referred to as a magic cookie or token, and is described in more detail below.

To illustrate the system 202 contemplated by the present invention, assume that the target user 108 is viewing content from the affiliate site 112 on the browser 208. The affiliate site 112 includes a banner advertisement 212 promoting the products or services offered by the merchant site 104. Moreover, the banner 212 incorporates a URL addressing a destination 214 at the merchant site 104. As mentioned earlier, the banner URL may send the target user 108 to the merchant site 104 directly, or may first send the target user 108 to a marketing site 114, and then to the merchant site 104.

When the target user 108 attempts to access the destination 214 referenced by the market sources 204, the merchant site 104 first presents a landing page 216 to the browser 208 before redirecting the browser 208 to the site destination 214. In a particular embodiment of the invention, the landing page 216 is invisible to the target user 108, quickly loading and then disappearing from the browser 208 without displaying any noticeable content. Although the landing page 216 is effectively imperceptible to the target user 108, the landing page 216 controls which destination page 214 the browser 208 is redirected to, as well as the contents of the client cookie 210. It is also contemplated that in other embodiments of the invention, the landing page 216 may be visible to the user.

According to one embodiment of the invention, the landing page 216 is presented to the target user 108 when a hypertext reference is made to a destination 214 in the merchant site 104. The hypertext reference may include an identification of the network source 204 referring the target user 108 to the merchant, a marketing campaign identifier, and other marketing information. For example, consider the following a example of a hypertext reference transmitted to the merchant site 104: http://www.ibm.com/golfclubs.html?affiliateid=1P02&campaignid=3476 This hypertext reference contains request for the golfclubs.html document (the destination page), an affiliate identification of 1P02, and a campaign identification of 3476. The landing page parses the information in the hypertext reference and may record some or all of the information in the client cookie 210. As discussed in detail below, the landing page 216 may set other fields in the client cookie 210 to help monitor browser destinations at the merchant site 104, track purchased items, and account for referral commissions.

Once the cookie is written, the landing page 216 redirects the browser 208 to a destination page 214 on the merchant site 104. The destination page 214 may be, for example, a shopping cart page 218, a registration page 220, a product information page 222, or a customer service page 224. The destination pages 214 are able to read the client cookie 210 and adjust their content according to the information provided in the cookie 210. For example, the shopping cart page 218 may read the client cookie 210 and apply a price rebate to users referred to by a particular market source 204.

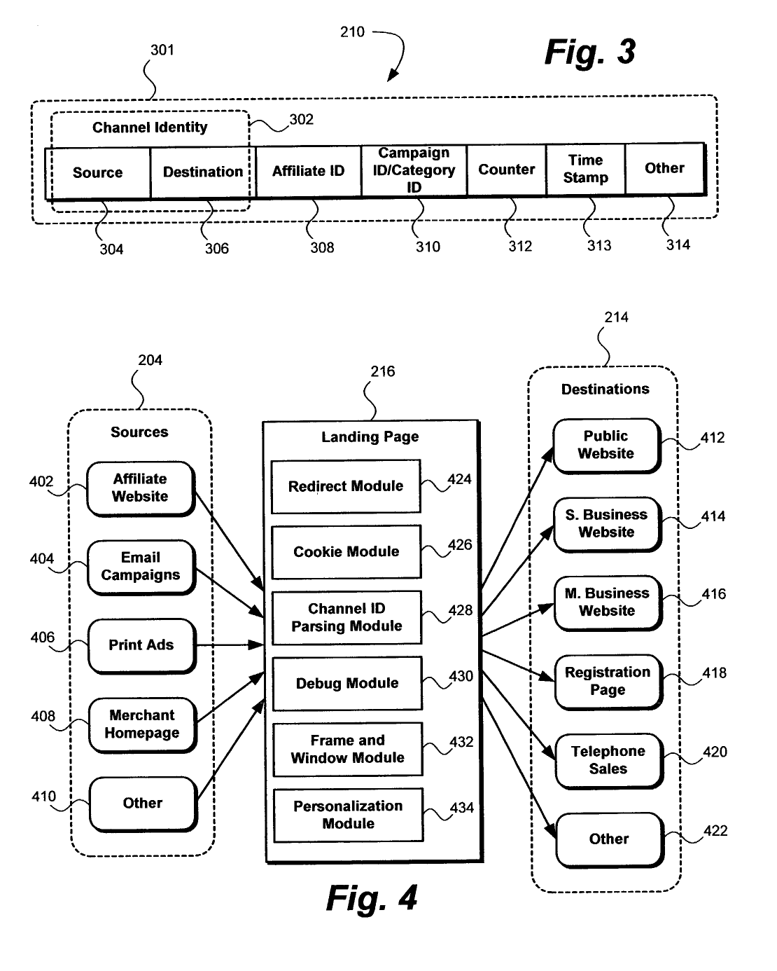

In FIG. 3, an exemplary client cookie 210 utilized by the present invention is shown. In a particular embodiment of the invention, the client cookie 210 is a small amount of data set by a merchant site and stored in computer readable media of the target user. Modern web browsers allow servers to read and write cookies in client memory, but can set strict limitations on the number and size of cookies. For example, current versions of Netscape Navigator(R) limit the total number of client cookies to three hundred, and allows only twenty cookies per domain name. In addition, the size of each cookie is limited to four kilobytes or two thousand characters.

As mentioned above, the client cookie 210 is embodied in computer readable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

In one embodiment of the invention, the client cookie 210 is a single referral identifier 301 comprising of a number of data fields. In particular, the referral identifier 301 contains a channel identity field 302 configured to identify the marketing channel delivering the target user to the merchant site. As discussed previously, the target user may come upon the merchant through a variety of marketing programs and advertising campaigns. Such programs and campaigns may involve affiliate companies external to the merchant, or may be carried out internally by the merchant.

The channel identity field 302 may be further divided into a source field 304 and a destination field 306. The source field 304 is configured to identify where the customer comes from. In a particular embodiment of the invention, a single character code is used in the source field 304 to identify both external marketing programs and internal marketing programs. For example, the letter “A” in the source field 304 can be used to identify an affiliate marketing program, the letter “E” can be used for an e-mail campaign program, “P” for a printed advertisement program, “I” for internal marketing programs originating at the merchant's on-line store, and so on.

The destination field 306 may be used to track various destinations, portals, or group sites that the target user is directed to once arriving at the merchant site. Again, a single character code may be employed in the destination field 306 to distinguish the different possibilities. For example, “S” may be used to indicate a small business destination, and “M” can be used for a medium business destination, “B” to designate both small and medium business centers, “F” for a public center, “H” for a home business center, and so on.

The referral identifier 301 may also include an affiliate identifier field 308 to record which affiliate directed the target user to the merchant site. The affiliate identifier field 308 can be used to determine the commission to be paid to the referring affiliate.

The campaign identity or category identity field 310 can be used to record a particular campaign or promotion identity from an e-mail or printed advertisement campaign, thereby allowing the merchant to track the responsiveness and effectiveness of each campaign. For affiliate marketing, this data field captures the product or category identity to which a particular banner directs the target user. This identifier enables the merchant to correlate a sale to one or more referrals, thus providing a more accurate means for determining and distributing the sales commission among multiple affiliates that a customer to the merchant.

It is contemplated that the referral identifier 301 can include various other fields 314 to record information relevant to the merchant. For example, the referral identifier 301 may further include a counter field 312 to record the number of times a customer has visited an affiliate site and clicked on the merchant's banner. This counter provides useful marketing information about the customer's interest and the popularity of the marketing program.

A time stamp field 313 can be utilized to store the referral date from an affiliate site or the expiration date of sales attributable to an affiliate site. In other words, the time stamp field 313 can indicated at what point in time an affiliate site is no longer entitled to a sales commission. Since the time stamp is specific to a referral or marketing channel, the merchant can specify a different expiration duration for each channel (e.g. 90 days for affiliate marketing, 30 days for e-mail campaigns). The time stamp field 313 also allows the merchant to enforce its business policy, such as removing an expired referral identifier 301, incrementing the counter 312, or updating the category identity field 310 of an active referral identifier 301.

The referral identifier 301 can also be used to track the target user's shopping habits and browsing history, the browser name and version number of the user, the amount of browsing time spent by the user before a purchase is made, the number of web pages the user browsed before making a purchase, the product identity numbers the user put in the shopping cart, and so on. Furthermore, and as discussed in more detail below, the client cookie 210 may include several referral identifiers 301 to record customer referrals from several marketing channels.

The referral identifier fields 302-314 may be delimited using various means known in the art. For example, the fields may be separated from each other using a special character, such a tab or comma character. Alternatively, each field may be a predetermined length such that the exact location of a particular field can be determined relative to the beginning of the cookie. Other data field separation techniques known in the art may be utilized by the present invention.

The client cookie 210 may be embodied as a temporary cookie or a permanent cookie. A temporary cookie is deleted from the client's memory once the client-server session is terminated. Thus, if the client cookie 210 is a temporary cookie, the merchant site can monitor client navigation and actions within a particular session, but not from one session to another.

A permanent cookie, unlike a temporary cookie, continues to exist in client memory even after the client-server session has terminated. In a particular embodiment of the invention, the client cookie 210 can be configured as a permanent cookie with a certain expiration date or lifetime. In such a configuration, the tracking of sales from multichannel marketing programs continues until the cookie's expiration date. For example, during a particular network session, a user is referred by an affiliate to the merchant's on-line store. Furthermore, the client cookie 210 used is a permanent cookie set to expire after 90 days. Although the user does not purchase any items during the initial network session, the affiliate will receive commission for purchases made by the user within the 90 day expiration date of the cookie, even if the user was not referred to the on-line store by the same affiliate subsequent times. In a particular embodiment of the invention, the cookie expiration date can be different for different marketing programs.

It is contemplated that the client cookie 210 may be used to establish marketing rules giving referral credit to one marketing channel over another when multiple references to the merchant site are made by different marketing channels before the expiration date of a permanent cookie. One conceivable rule may be that external marketing programs take precedence over internal marketing programs, and subsequent external marketing programs also take precedence over a previous external marketing program. In other words, an affiliate marketing program always receives referral credit over an internal email campaign during the lifetime of the cookie. As a result, source=E will become source=A if the user is referred by the e-mail marketing program first, and then by an affiliate marketing program. On the other hand, source=A will remain the same if the user is referred by the affiliate marketing program first and then by an e-mail marketing program. However, tracking of the originated sale can always be credited to the most recent marketing channel referring the user to the merchant's on-line store within the same multichannel marketing program.

The single client cookie 210 of the present invention is usable for different marketing programs, thereby advantageously and efficiently combining multiple marketing channel tracking functions into a single identifier. This helps ensure that the maximum number of cookies allocated per domain name by a browser program is not exceeded. Other advantages of the client identifier design include a small amount of disk space required to store permanent identifiers and the improved performance of storing and retrieving such identifiers. Furthermore, the present invention simplifies tracking of multichannel marketing programs by providing one client cookie structure for use with various marketing programs. As a result, code changes on the back end procurement system are not required when new marketing programs are added into the merchant site, or old marketing programs are modified or removed from the merchant site.

In FIG. 4, a landing page 216 contemplated by the present invention is shown. In one embodiment of the invention, all new merchant sessions originating from various marketing sources 204 are initially directed to the landing page 216. As mentioned previously, the various marketing sources 204 may include affiliate web sites 402, e-mail campaigns 404, print advertising promotions 406, the merchant's web site home page 408, and other sources 410, such as television advertisement campaigns, e-coupons, and e-rebates promotion programs.

Once the landing page 216 is loaded, a client cookie is recorded in the target user's memory, as described above. Next, the landing page 216 redirects the incoming network traffic to various destinations 214 based on marketing parameters from the hypertext reference of the marketing sources 204, as well as other navigation and control logic. These destinations 214 may include the merchant's public web site 412, a website targeted to small-sized businesses 414, a website targeted to medium-sized businesses 416, a registration web page 418, a telephone sales representative 420, and other locations 422.

The landing page 216 can include several modules to centralize, control, and distribute traffic from multiple marketing programs, thereby beneficially saving time and effort in configuring and administrating the merchant site. The landing page 216 may include a redirect module 424 to forward the client to a destination page 214 based on various marketing and network conditions. For example, logic within the redirect module 424 may be used to route customers to different destinations 214 based on the different referring marketing sources 204. The redirect module 424 may also selectively route a customer to different destinations 214 based on the number of customer visits to the network site. For example, the landing page 216 can send a first time customer to a special promotional page. Additionally, in the case where the current server becomes overloaded due to high network traffic, the redirect module 424 may be configured to redirect customers to alternative servers, or to display a delay message and a phone number to call for better service.

A cookie module 426 at the landing page 216 is configured to construct and store one or more client cookies in memory. As mentioned above, the client cookie can be used to track various marketing channels, count customer visits, and control commission expirations. The cookie module 426 may communicate with a channel identity parsing module 428, which is used to parse and construct the marketing channel identity of the referring marketing channel. The marketing channel identity is based on the destination URL and the URL of the referring page and other parameters.

In one embodiment of the invention, the landing page 216 includes a debug module 430 to help maintain, upgrade and support the merchant site. For example, the debug module 430 may be configured to display server status and environment variables and parameters when a special debug flag within hypertext reference is passed to the landing page 216. Thus, the site administrator can use the landing page 216 to detect and correct errors in the merchant's site.

The landing page 216 may further include a frame and window module 432 to handle frame blocking, either by breaking out from a browser frame or launching a new browser window. The frame and window module 432 can also provide navigation logic to prevent the customer from returning to the landing page 216 by modifying the browser's visit history. The frame and window module 432 may be used to compensate for different browser types, browser versions, and other client configurations.

A personalization module 434 may also be included in the landing page 216. The personalization module 434 is used to collect additional customer information, such as the number of visits by the customer and the type of browser the customer is using. The personalization module 434 can be used to help customize the subsequent merchant pages according to the information obtained.

It is contemplated that the landing page modules may be executed on at the merchant site, the client, or partially executed at both network locations. In one embodiment of the invention, the landing page modules are formatted as Java Script encoded within the landing page 216. The modules may be coded using other programming languages known by those skilled in the art, such as Active Server Pages (ASP), Java Server Pages (JSP), PHP, etc.

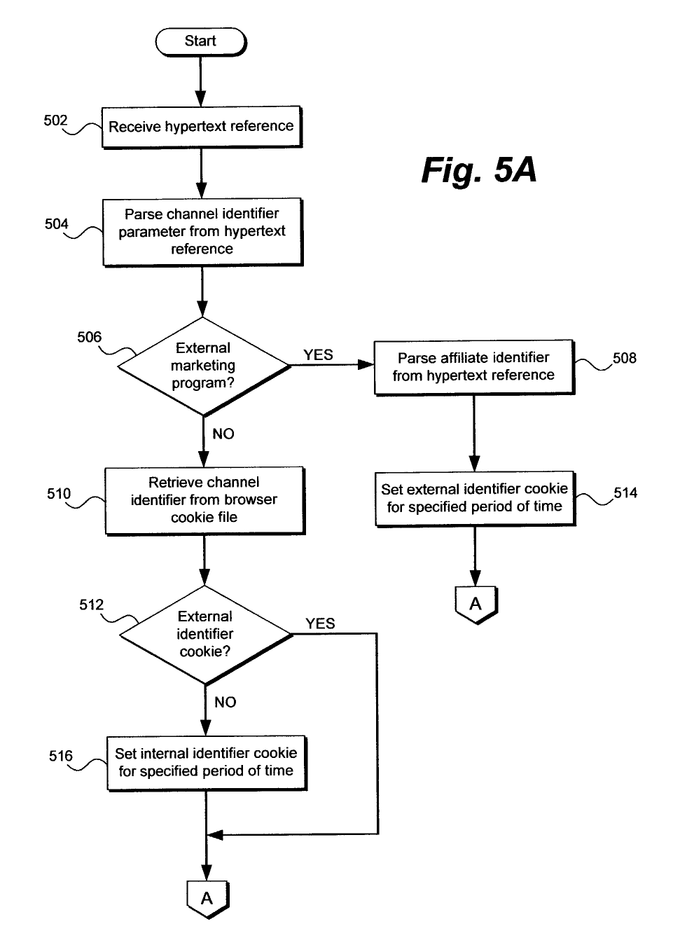

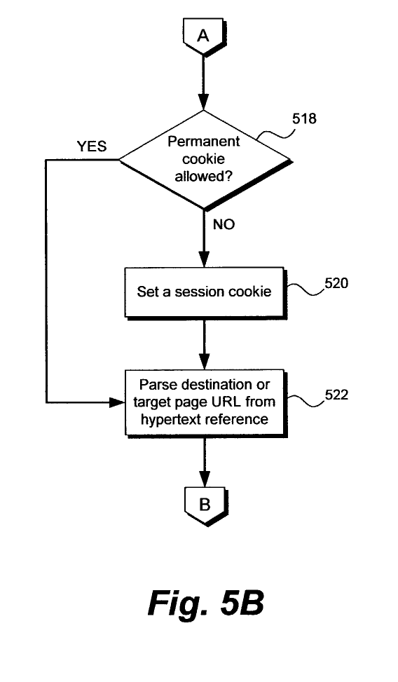

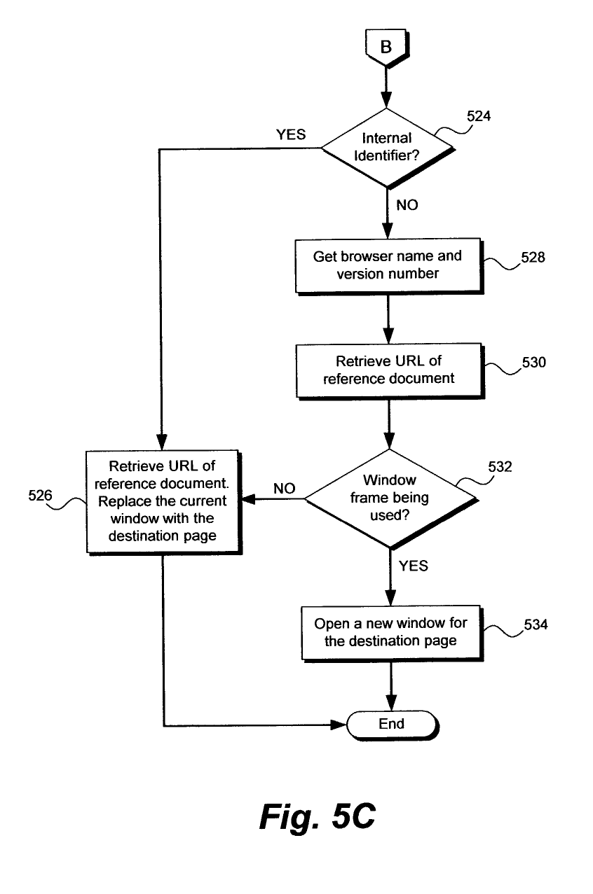

In FIGS. 5A-5C, a flowchart for providing content from a merchant site to a target user over a computer network, as contemplated by one embodiment of the present invention, is shown. It should be remarked that the logical operations shown may be implemented (1) as a sequence of computer executed steps running on a computing system and/or (2) as interconnected machine modules within the computing system. The implementation is a matter of choice dependent on the performance requirements of the system implementing the invention. Accordingly, the logical operations making up the embodiments of the present invention described herein are referred to alternatively as operations, steps, or modules.

Operational flow begins with receiving operation 502. During this step, the merchant site receives a request for information from the target user in the form of a hypertext reference. As mentioned above, the request includes marketing information, such as a source parameter identifying the marketing channel referring the target user to the merchant site. After the receiving operation 502 is completed, flow continues to parsing operation 504.

In parsing operation 504, the channel identifier is extracted from the hypertext request. As discussed above, the channel identity may be a two character code, such as AF for affiliate to public site, AM for affiliate to medium business site, ES for e-mail campaign to small business site, and IM for public site to medium business site. Typically, this process involves searching for keywords and special field delimiters identifying particular entries within the request. Once the channel identifier information is parsed from the request, control passes to query operation 506.

In query operation 506, the channel identifier is tested to determine whether the target user was referred to the merchant site from an internal marketing program or an external marketing program. If the target user was referred to the merchant site from an external marketing program, control flow passes to parsing operation 508 where the request is further parsed to extract an affiliate identification value. Control then passes to setting operation 514. If the target user was referred to the merchant site from a lower priority marketing program, control flow passes to retrieving operation 510.

In retrieving operation 510, the channel identifier for a preexisting client cookie of the merchant site, if one exists, is retrieved. Once retrieved, control passes to checking operation 512 where the preexisting channel identifier is examined. If the preexisting channel identifier is an external marketing source, the external marketing source takes precedence over the internal marketing source, no identifier cookie is set and control passes to query operation 518.

In setting operation 514, the newly received or preexisting external channel identifier is recorded in the client cookie. In this manner, new external channel identifiers overwrite old external channel identifier. After the setting operation 514 is completed, control passes to query operation 518.

Thus, new external marketing sources take precedence over old external marketing sources. On the other hand, new internal channel identifiers do not overwrite old external channel identifiers, thus external marketing sources take precedence over internal marketing sources. In addition, the expiration date of the client cookie is set in setting operation 514. If, at checking operation 512, it is determined that a channel identifier does not exist, or is an internal channel identifier, the new internal channel identifier is written in the client cookie at setting operation 516. Setting operation 516 also records the expiration date of the client cookie. After the setting operation 516 is completed, control passes to query operation 518.

In query operation 518, the browser is checked whether permanent cookies are permissible. If permanent cookies are not allowed, control passes to setting operation 520 where the client cookie is reconfigured as a session cookie. After setting operation 520 is completed, or if query operation 518 determines that permanent cookies are permissible, control passes to parsing operation 522.

In parsing operation 522, the hypertext request is once again parsed to extract the destination page. The destination page may be internal to the merchant site or external to the merchant site. If, at checking operation 524 it is determined that the destination page is internal to the merchant site, control passes to replacing operation 526. At replacing operation 526, the browser is redirected to the destination page and content is loaded into the current browser window. If, at checking operation 524, it is determined that the destination page is external to the merchant site, control passes to retrieving operation 528.

At retrieving operation 528, the browser name and version number is retrieved. Different browser types and browser version can display content differently. Thus, by ascertaining the browser used, content can be adjusted as needed. Next, at retrieving operation 530, the URL of the reference document is retrieved. After the retrieving operation 530 is completed, control passes to determining operation 532.

At determining operation 532, the browser is checked to determine if frames are being used to display information. If frames are not being used, control passes to replacing operation 526 where the browser is redirected to the destination page. If frames are being used, control passes to opening operation 534. At opening operation 534, a new browser window is opened and the browser is redirected to the destination page.

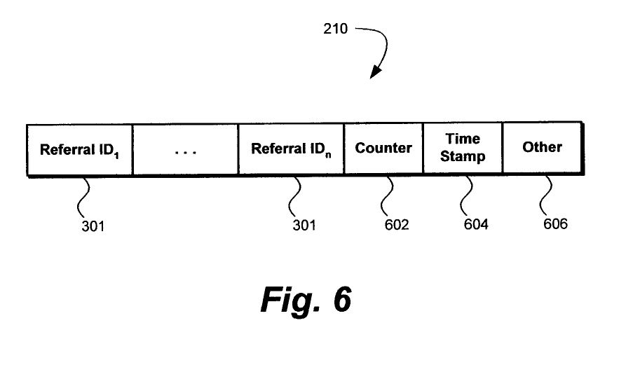

In FIG. 6, another embodiment of the client cookie 210 contemplated by the present invention is shown. The cookie 210 supports multiple referral identifiers 301 from multiple referring marketing channels. As mentioned above, the ability to record referral identifiers 301 from two or more marketing channels is particularly beneficial to merchants conducting a large number of marketing campaigns and/or participating with a large number of affiliates. A collection of referral identifiers 301 helps the merchant better understand customer behavior by identifying correlations among the different campaigns, channels and referrals, redefine customer segments, and improve future marketing campaigns.

The client cookie 210 may also include a global counter field 602, global time stamp field 604, and other fields 606 as needed. The global counter 602 can be used to record the number of times a customer has visited the merchant web site so that a first time or frequent visitors can be identified for special promotions. The time stamp 604 can be used to store the expiration date of the cookie 210. Thus, the referral identifiers 318 from different multichannel marketing programs can be conditionally updated or overwritten by the old and new multichannel marketing program with cookie expiration date being preserved, extended, or merged with the expiration date of the new marketing program depending on the business logic set by the merchant and its affiliate marketing program.

The foregoing description of the invention has been presented for purposes of illustration and description. Thus, the above description is not intended to be exhaustive or to limit the invention to the precise form disclosed, and other modifications and variations may be possible. The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for providing content from a merchant site to a target user over a computer network, the target user being referred to the merchant site by a marketing source, the method comprising:
receiving a request for information from the target user;
providing a landing page to the target user in response to the request, the landing page configured to record an identifier of the marketing source in a client cookie; and
redirecting the target user from the landing page to a destination page, the destination page providing content to the target user.

2. The method of claim 1, wherein redirecting the target user comprises selecting the destination page based, at least partially, on the marketing source.

3. The method of claim 1, wherein redirecting the target user comprises selecting the destination page based, at least partially, on network traffic volume at the merchant site.

4. The method of claim 1, wherein redirecting the target user comprises selecting the destination page based, at least partially, on a number of visits to the merchant site by the target user.

5. The method of claim 1, further comprising parsing marketing data from the request for information.

6. The method of claim 1, further comprising recording a time stamp for the marketing source.

7. A landing page adapted to be downloaded by a client from a server over a computer network, the client being referred to the server by at least one marketing channel, the landing page comprising:
a redirect module configured to redirect the client to a destination page; and
a cookie module configured to store a computer readable client cookie in memory, the client cookie configured to record an identifier of the at least one marketing channel.

8. The landing page of claim 7, wherein the redirect module is further configured to redirect the client to the destination page based, at least partially, on the marketing channel.

9. The landing page of claim 7, wherein the cookie module is further configured to record a time stamp for the marketing channel.

10. The landing page of claim 7, further comprising a debug module, the debug module configured to display debug variables when a debug flag is passed to the landing page.

11. The landing page of claim 7, further comprising a frame and window module, the frame and window module configured to customize a browser window according to client configurations.

12. The landing page of claim 7, wherein the client cookie is further configured to identify the destination page.

13. The landing page of claim 7, wherein the client cookie is further configured to identify a number of times the client visited the server.

14. A system for controlling the content delivered to a target user from a merchant site in a network environment, the network environment including a plurality of network sources, the system comprising:
a network source providing the target user with a link to the merchant site; and
a landing page adapted to be downloaded by the target user from merchant site over the computer network, the landing page including a redirect module configured to redirect the target user to a destination page of the merchant site, and a cookie module configured to store a computer readable client cookie in memory, the client cookie configured to identify the network source.

15. The system of claim 14, wherein the landing page is further configured to parse marketing data from the link.

16. The system of claim 14, wherein the redirect module is further configured to redirect the target user to the destination page based, at least partially, on the network source.

17. The system of claim 14, wherein the redirect module is further configured to redirect the target user to the destination page based, at least partially, on network traffic volume at the merchant site.

18. The system of claim 14, wherein the redirect module is further configured to redirect the target user to the destination page based, at least partially, on a number of visits to the merchant site by the target user.

19. The system of claim 14, wherein the redirect module is further configured to redirect the target user to the destination page based, at least partially, on a debug flag.

20. The system of claim 14, wherein the client cookie is further configured to identify the destination page.

21. A computer program product embodied in a tangible media comprising:
computer readable program codes coupled to the tangible media for providing content from a merchant site to a target user over a computer network, the target user being referred to the merchant site by a marketing source, the computer readable program codes configured to cause the program to:
receive a request for information from the target user;
provide a landing page to the target user in response to the request, the landing page configured to record an identifier of the marketing source in a client cookie; and
redirect the target user from the landing page to a destination page, the destination site providing content to the target user.

22. The computer program product of claim 21, wherein the program code configured to cause the program to redirect the target user is configured to select the destination page based, at least partially, on the marketing source.

23. The computer program product of claim 21, wherein the program code configured to cause the program to redirect the target user is configured to select the destination page based, at least partially, on network traffic volume at the merchant site.

24. The computer program product of claim 21, wherein the program code configured to cause the program to redirect the target user is configured to select the destination page based, at least partially, on a number of visits to the merchant site by the target user.

25. The computer program product of claim 21, further comprising program code configured to cause the program to parse marketing data from the request for information.

26. The computer program product of claim 25, further comprising program code configured to cause the program to record at least some of the marketing data in the client cookie.

27. A client cookie embodied in tangible media at a client computer, the client computer being referred to a server destination by a marketing channel, the client cookie comprising:
a channel identity field configured to record an identity of the marketing channel; and
a time stamp field configured to record an expiration date of at least one commission attributable to the marketing channel.

28. The client cookie of claim 27, further comprising an affiliate identification field configured to record an affiliate identifier for the marketing channel.

29. The client cookie of claim 27, further comprising a campaign identification field configured to record an campaign identifier for the marketing channel.

30. The client cookie of claim 27, wherein the client cookie is configured to record a plurality of referral identity fields for various marketing channels.

31. The client cookie of claim 30, further comprising a category identifier field configured to help distribute a sales commission between the various marketing channels.
